(19) United States
(12) Patent Application Publication
(10) Pub. No.: US 2010/0309662 A1
(43) Pub. Date: Dec. 9, 2010

(54) LED lighting fixture

(76) Inventor: Jin Song Zheng, West Covina, CA (US)

Correspondence Address: DAVID AND RAYMOND PATENT FIRM, 108 N. YNEZ AVE., SUITE 128, MONTEREY PARK, CA, 91754, US

(21) Appl. No.: 12/455,775

(22) Filed: Jun. 4, 2009

(51) Int. Cl. F21V 1/00; F21S 4/00; F21V 29/00

(52) U.S. Cl. 362/235; 362/249.02; 362/373; 362/294

(57) ABSTRACT

A LED lighting fixture includes a LED light arrangement and a supporting frame for supporting the LED light arrangement. The LED light arrangement includes one or more diodes and a circuit layer for operatively driving the diodes. The supporting frame includes a heat transmitting wall having a first side for supporting the LED light arrangement thereon and a second side to define a heat transferring chamber thereat in a concealed manner, and a concealing frame extended from the transmitting wall to form the heat transferring chamber therewithin. A plurality of heat transmitting fins further protrudes out from the second side to enlarge the heat conduction area, so as to enhance the heat conductive transferring rate. The heat transmitting fins are concealed within the heat chamber via the concealing frame, so that the overall size and outer structure of the LED lighting fixture is remaining the same.

### BACKGROUND OF THE PRESENT INVENTION

1. Field of Invention

The present invention relates to a light fixture, and more specifically relates to a LED light fixture, which has a supporting frame for supporting a LED light arrangement and for dissipating the heat generated from the LED light arrangement to exterior, so as to minimize the overall size and remain the outer smooth surface of the LED lighting fixture.

2. Description of Related Arts

The conventional lamp, in order to generate the higher light intensity for illuminating the environment, usually accumulates considerable heat energy from the lamp of light source. The overheated of the light apparatus with the conventional lamp is one of the reasons of the short life of conventional light apparatus.

Currently, LED is gradually replacing the conventional light source, since the LED is known as its high light intensity and low power consuming. LEDs are also efficient in that they produce more lumens per watt, so that the heat generated from the LED per light intensity unit is less than most of the conventional lamps. Thus, the LEDs are more efficient, have longer lamp life, and higher durability. Still over a long period of using time of the LED, the heat generated from the LED light source and the driven circuit connected to the LED needs to be transferred to ensure the normal performance of the LED.

For the pursuit of higher and higher light intensity, recently a higher brightness LED is applied on lots of lighting apparatus for commercial or other illuminating purposes. Those higher brightness LEDs, while generate higher light output, also generate greater amount of heat than standard LEDs. If the heat can not be efficiently dissipated, it may decrease the stability for normally performing the LED due to the damage of the driven circuit required to drive the LED. The fail of dissipating heat properly may also affect the light output and shorten the long life and durability of LED.

Therefore, the existing technique may apply a heat dissipation arrangement thermally connected to the driven circuit and LED to conductively transfer the heat generated therefrom. Some of the heat dissipation arrangements adapt a plurality of fins made by heat conductive material, wherein the fins are outwardly protruding from the LED light unit to efficiently increase the heat conductive area, so as to increase the efficiency of heat transfer.

However, the protruded fins of LED apparatus has the drawbacks of installing the LED apparatus with other object or surfaces, such as a wall, a corner, or in the closet due to its uneven surface of the protruding fins. Furthermore, the heat conductive material of the fins may has free electrons generated from the current or the driven circuit of LED and distributed on the surface of fins, so that the protruding fins may easily to accumulate dust thereon, so as to decrease the efficiency of heat transfer. It may cause the shortage of the driven circuit to reduce the performance of the LED.

For example, a LED light apparatus is installed in a cabinet of kitchen. The LED apparatus is normally mounted on an interior wall within the cabinet. After operating the LED apparatus for a while, lots of dust, dust mind, or germs usually accumulate on the protruding fins, so as to dramatically reduce the heat dissipating efficiency. Even a user wants to clean or wipe out the dust on the surface of the protruding fins, it is almost impossible. It is hard to reach the rear side of the LED, which provides the protruding fins thereon, within the tiny interior space of the cabinet. The dust accumulated between the tiny gaps of two neighboring fins is incredibly hard to reach for wiping the dust off. Thus, the application of LED apparatus is limited.

Another type of heat dissipation arrangement for LED is to apply a heat sink sealably encloses the LED electric components therein. However, the outer surface of the heat sink, which is for conductively transferring the heat within the heat sink generated from the LED or the circuit board to the surroundings, has limited heat conductive surface. To increase the entire heat sink volume to enlarge the outer surface maybe applied for efficiently removing the heat for stably performing the LED. Therefore, the entire LED apparatus may be bulky.

In order to resolve the limited surface of the heat sink, the heat sink may further have a plurality of fins integrally and outwardly protruding from the outer surface of the heat sink. However, the unsmooth outer surface of those protruding fins has the cleaning issue as mentioned above. It also increases the total volume of the LED light apparatus or fixture.

### SUMMARY OF THE PRESENT INVENTION

A main object of the present invention is to provide a LED light fixture, which is able to efficiently remove the heat generated from the LED, so as to enhance the efficiency of heat transfer.

Another object of the present invention is to provide a LED light fixture, wherein an outer surface of a concealing frame is smooth.

Another object of the present invention is to provide a LED light fixture, which has a heat dissipation arrangement, meanwhile, minimize the total size of the LED light fixture.

Another object of the present invention is to provide a LED light fixture, which is able to conductively and convectively transfer heat.

Another object of the present invention is to provide a LED light fixture, which has a heat transmitting wall thermally connecting with a LED arrangement for conductively transferring the heat, and a concealing frame to define a heat transferring chamber within the heat transmitting wall and the concealing frame for convectively transferring the heat.

Another object of the present invention is to provide a LED light fixture, which has a plurality of heat transmitting fins provided within the heat transferring chamber and extended from the heat transmitting wall, so that the fins efficiently enhance the heat transferring ability, so as to have a smooth outer surface of the concealing frame and minimize the size of LED light fixture.

Another object of the present invention is to provide a LED light fixture, which has one or more ventilation openings provided at the outer surface of the concealing frame to communicate with a gas within the heat transferring chamber, so as to enhance the ventilation or heating convection between the gas in the heat transferring chamber and the surroundings.

Accordingly, in order to accomplish the above objects, the present invention provides a LED light fixture, which comprises a LED light arrangement having one or more diodes as the light source, and a supporting frame made by heat conductive material to support the LED light arrangement.

The supporting frame comprises a heat transmitting wall having a first side and a second side, wherein the first side is for supporting the LED light arrangement thereon, and the second side defines a heat transferring chamber thereat in a concealed manner for containing gaseous in the heat transferring chamber. Therefore, the heat transmitting wall is arranged for conductively transferring heat from the diodes at the first side to the heat transferring chamber at the second side, so as to effectively dissipating the heat from the gaseous heat transferring chamber to the surrounding through automatically ventilation mainly via heat convection.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a LED lighting fixture according to a first preferred embodiment of the present invention.

FIG. 2 is a side sectional view of the LED lighting fixture according to the above first preferred embodiment of the present invention.

FIG. 3 is a front sectional view of the LED lighting fixture according to the above first preferred embodiment of the present invention.

FIG. 4 is a perspective view of a LED lighting fixture according to a second preferred embodiment of the present invention.

FIG. 5 is a side sectional view of the LED lighting fixture according to the above second preferred embodiment of the present invention.

### DETAILED DESCRIPTION OF THE PREFERRED EMBODIMENT

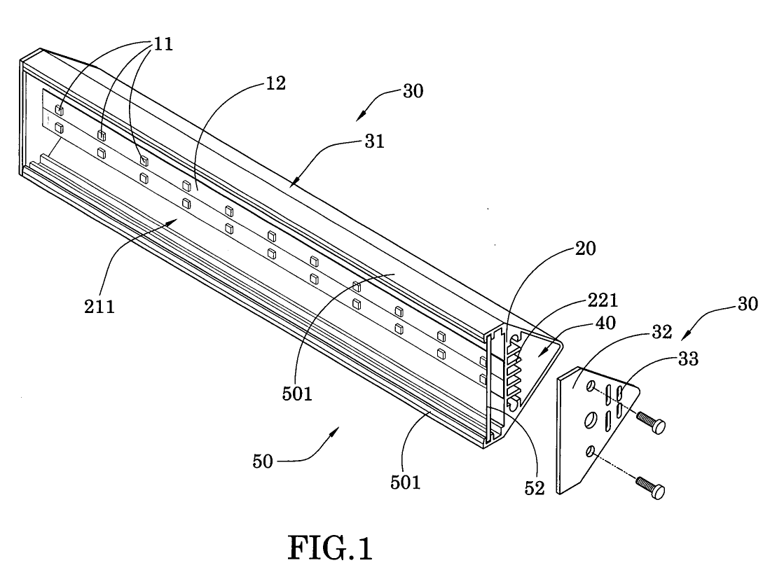

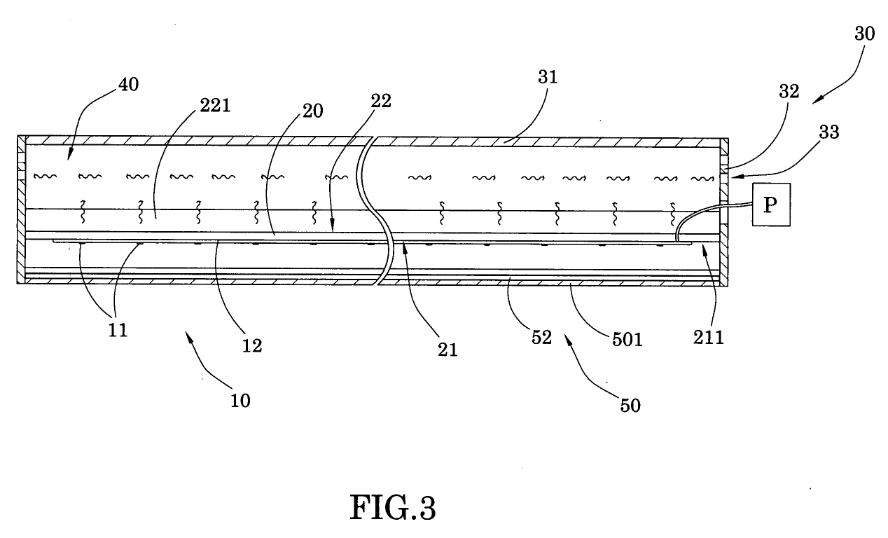

Referring to FIGS. 1 to 3 of the drawings, a LED light fixture according to a preferred embodiment of the present invention is illustrated, wherein the LED light fixture comprises a LED light arrangement 10 and a supporting frame for supporting the LED light arrangement 10. The LED light arrangement 10 comprises one or more diodes 11 as a light source, and a circuit layer 12 electrically connected to each of the diodes 11 for operatively controlling the LED light performance.

The supporting frame, which is made of heat conductive material, comprises a heat transmitting wall 20 having a first side 21 and a second side 22, wherein the first side 21 is for supporting the LED light arrangement 10 thereon, and the second side defines a heat transferring chamber 40 thereat in a concealed manner for containing gaseous in the heat transferring chamber 40. Therefore, the heat transmitting wall 20 is arranged for conductively transferring heat from the diodes 11 at the first side 21 to the heat transferring chamber 40 at the second side 22, so as to effectively dissipating the heat from the gaseous at the heat transferring chamber 40 to the surroundings through automatically ventilation, which is mainly depends on heat convection. Accordingly, the circuit layer 12 can be overlappedly coated on the first side 21 of the heat transmitting wall 20 to electrically couple with the diodes 11. Alternatively, the circuit layer 12 can be directly printed on the first side 21 of the heat transmitting wall 20 to electrically couple with the diodes 11.

In other words, the heat generated from the diodes 11 is conductively transferred via the heat transmitting wall 20 from the first side 21 to the second side 22, and then convectively transferred the heat from the second side 22 of the heat transmitting wall 20 to the gaseous within the heat transferring chamber 40.

The supporting frame also comprises a concealing frame 30, wherein the concealing frame 30 is integrally extended from the heat transmitting wall 20 to form the heat transferring chamber within the heat transmitting wall 20 and the concealing frame 30. The heat transmitting wall 20 is preferably rectangular shape.

Accordingly, the concealing frame 30 comprises a concealing wall 31 and two end walls 32, wherein the concealing wall 31 is longitudinally extended from two longitudinal sides of the heat transmitting wall 20 to form the heat transferring chamber 40 within the heat transmitting wall 20 and the concealing wall 31. The end walls 32 are further coupling with two transverse edges of the heat transmitting wall 20 to conceal the heat transferring chamber 40 within the heat transmitting wall 20, the concealing wall 31 and the two end walls 32. It is worth to mention that the concealing wall 31 and end walls 32 can be made by a heat-resistant material, which may be plastic, metal, or any other heatproof material, and preferably made by a heat conductive material, so that the heat is capable of being conductively transferred from the concealing wall 31.

In order to ventilate the gaseous within the heat transferring chamber 40, a plurality of ventilation openings 33 are further provided at the concealing frame 30 for thermally communicating with the heat transferring chamber 40 with the surroundings, which may be at the cooler room temperature than the temperature of the gaseous within the heat transferring chamber 40. It is worth to mention that the heat transferring chamber 40 is preferably air to transfer the heat from the LED arrangement 10 through the heat transmitting wall 20. It is appreciated that any existing cooling agent can be guided to pass through the heat transferring chamber 40 to effectively guide the heat out of the LED arrangement 10.

It is appreciated that the ventilation openings 33 may be provided at the concealing wall 31 and/or end walls 32 of the concealing frame 30. In this preferred embodiment, the ventilation openings 33 are respectively provided at the two end walls 32 to convectively transfer the heat from the heat transferring chamber 40 to exterior.

The circuit layer 12 of the LED light arrangement 10 is fixedly provided on the first side 21 of the heat transmitting wall 20 for being supported thereon. The circuit layer 12 is adapted for operatively and electrically connected to a power source, such as an external AC power source, for providing an electric power for performing the diodes 11, so that the circuit layer 12 may generates a considerable among of heat generated therefrom. Therefore, the heat transmitting wall 20 being attached with the circuit layer 12, which is electrically connecting and supporting the diodes 11 thereon, is thermally communicating with the diodes 11 and the circuit layer 12 for conductively transferring the heat to the surroundings through the heat transferring chamber 40.

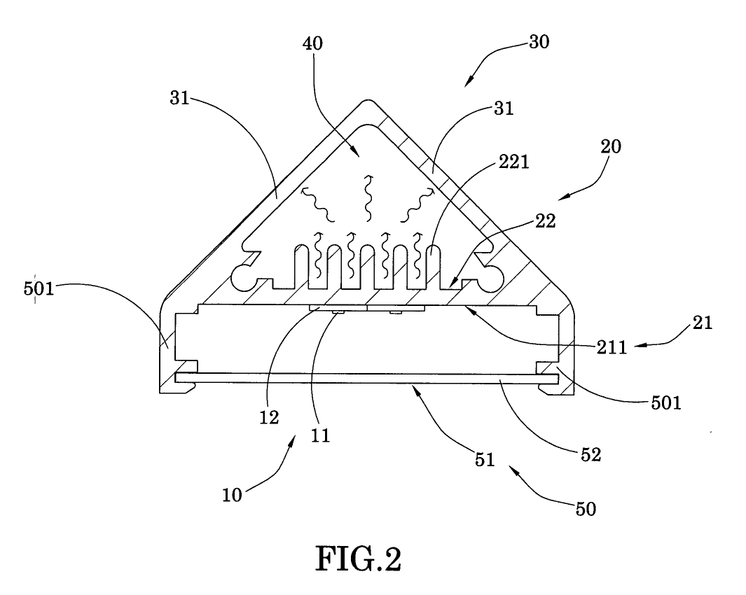

As shown in FIGS. 1 and 2, a plurality of heat transmitting fins 221 are further provided at the second side 22 of the heat transmitting wall 20, wherein the heat transmitting fins 221 are extended from the second side 22 to protrude toward the heat transferring chamber 40, so that the heat generated from the diodes 11 and the circuit layer 12 of LED light arrangement 10 are able to be more conductively transferred due to the enlarged heat conduction area of the protruding heat transmitting fins 221. Thus, the heat generated from the LED light arrangement 10 is able to be efficiently removed away therefrom, so as to ensure the stability of normally operating the LED light fixture.

In other words, the heat transmitting fins 221 protruded out from the second side 22 of the heat transmitting wall 20, preferably in a parallel protruding manner to integrally extended from the second side 22 of the heat transmitting wall 20, increases a total heat conducting surface of the heat transmitting wall 20 to conductively transfer the heat from the first side 21 to the second side 22, so as to minimize a heat transferring rate for increasing the heat transferring efficiency without changing the original configuration of the supporting frame. Thus, the total size of the LED light fixture is remaining the same, so as to minimize the volume of the LED light fixture.

Accordingly, the heat generated from the diodes 11 and the circuit layer 12 directly fixed on the first side 21 is able to be more efficiently transferred to the surroundings through the heat transmitting fins 221 at the second side 22 for conductively transferring the heat to the heat transferring chamber 40 to convectively transferring the heat to the exterior. Through the increased heat conducting area of the heat transmitting fins 221 to thermally communicate with the heat transferring chamber 40 with the surroundings, the heat is able to be removed for remaining the operating temperature of the LED light arrangement 10.

It is worth to mention that the heat transmitting fins 221 enlarged the heat conducting surface are concealed within the heat transferring chamber 40 via the concealing frame 30, so that the dust existed in the surroundings is relatively more difficult to stick on the heat transmitting fins 221, so as to prevent the decreasing of heat transferring rate to cause the heat over accumulated within the supporting frame 30. The over accumulated heat may lead to the abnormal operation of the LED light fixture and reduce the life time and durability thereof.

It is appreciated that the heat transmitting fins 221 being concealed within the supporting frame 30 not only increases the heat transferring efficiency via enlarging the heat conducting surface, but also remains a smooth outer surface of the concealing wall 31, so as to be easily installed on the wall or with other objects.

As mentioned above, the smooth outer surface of the concealing wall 31 concealing the heat transmitting fins 221 therewithin is a continuous surface, which has no sharp corners thereon, such as a smoothly wavy surface or a surface having a plurality of small dots on the surface, such that the LED lighting fixture also has a smooth outer surface for easily cleaning purpose. In other words, the smooth outer surface of the concealing wall 31 of the concealing frame 30 has no tiny gaps thereon, so that it is capable of easily cleaning the outer surface of the concealing wall 31, such as wiping out the dust accumulated on the outer surface of the concealing wall 31, so as to retain the heat transferring rate.

The concealing wall 31 preferably has a V-shaped cross section longitudinal extended from the two longitudinal sides along the heat transmitting wall 20 to define a triangle cross section of heat transferring chamber 40 therewithin. In other words, the V-shaped concealing wall 31 and the heat transmitting wall 20 are formed a triangular column to define the heat transferring chamber 40 having the triangle cross section to conceal the heat transferring fins 221 therewithin.

The V-shaped concealing wall 31 has two flat surfaces to form the V-shape, wherein an outer surface of the two flat surfaces of the concealing wall 31 also has a smooth outer surface, so that it is easier for installation of the LED light fixture. An angle between the two flat surfaces of the V-shaped concealing wall 31 is preferably around 90 degree, so that the LED light fixture is able to be easily installed on a corner having about 90 degree as well. The angle between the two flat surfaces maybe variable and is able to be mounted on varieties of degree corners for illuminating the surroundings.

Each of the two end walls 32 preferably made by heat conductive material may further has a triangular shape in accordance with the triangle cross section shape of the heat transferring chamber 40, so as to conceal the heat transmitting fins 221 in the heat transferring chamber 40.

As mentioned above, the supporting frame further comprises a mounting frame 50 extended from the first side 21 of the heat transmitting wall 20 to form a lighting cavity between the heat transmitting wall 20 and the mounting frame 50, wherein the LED light arrangement 10 supported by the heat transmitting wall 20 is supported within the light cavity. The mounting frame 50 is extended from the first side 21 to define a light opening 51 of the light cavity for aligning with the diodes 11 of the LED light arrangement 10, so that the light generated from the diodes 11 is able to emit from the light opening 51. The mounting frame 50 is also preferably made by heat conductive material for enhancing the heat transferring ability.

The mounting frame 50 also comprises a transparent cover panel 52 supported at the light opening 51 to enclose the LED light arrangement in the light cavity between the cover panel 51, mounting frame 50, and the heat transmitting wall 20. Thus, the LED light arrangement 10 is able to be protected within the light cavity and emit the light generated from the diodes 11 through the transparent cover panel 52.

The mounting frame 50, as described in this embodiment, further comprise two mounting walls 501, which is preferably made by heat conductive material, wherein the mounting walls 501 are longitudinally and integrally extended from the first side 21 of the heat transmitting wall 20 to define the light opening 51, so as to support the cover panel 52 spacedly apart from the first side 21 of the heat transmitting wall 20.

The two end walls 32 of the concealing frame 30 are coupled at the two transverse sides of the concealing wall 31, heat transmitting wall 20, and mounting walls 501 to conceal the heat transferring chamber 40 and the light housing. In other words, the light housing supporting the LED light arrangement 10 therewithin is defined between the heat transmitting wall 20, the mounting walls 501, the end walls 32 and the transparent cover panel 52 in this preferred embodiment.

It is worth to mention that the heat generated from the LED light arrangement 10 also can be conductively removed from the mounting frame 50 and the concealing frame 30, which are preferably made by heat conductive material. It is appreciated that the concealing frame 30 or mounting frame 50 may be made by other materials, such as plastic, which is heat-resistant material for tolerate the heat generated from the LED light arrangement 10.

The heat transmitting wall 20 further has a reflective surface 211 thereon, wherein the reflective surface 211 is adapted for reflecting the light generated from the diodes 11 of the LED light arrangement 10, so as to enhance the light intensity for providing a relative more efficient LED lighting fixture.

Accordingly, the LED light fixture may also comprises one or more cable lines adapted for electrically connecting the circuit layer 12 of the LED light arrangement 10 to a power source for supplying the electric power to the LED light arrangement 10. The end walls 32 may further has one or more holes adapted for the cable lines to pass from the lighting cavity to exterior via the holes.

It is appreciated that in this preferred embodiment, the concealing frame 30 and mounting frame 50 may be integrally formed by injection molding method, such as plastic injection molding method or metal injection molding method. The concealing frame 30 may also integrally formed with the heat transmitting wall 20, which are both made by heat conductive material.

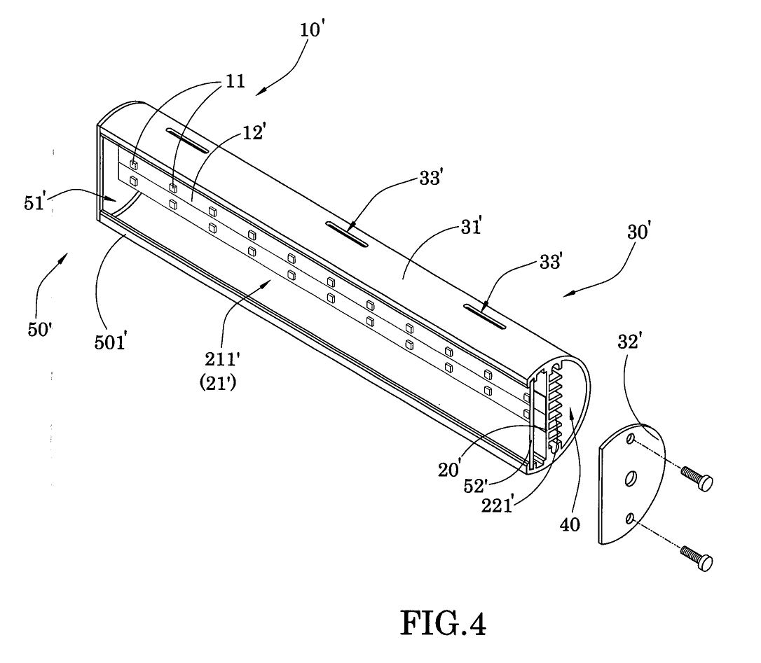

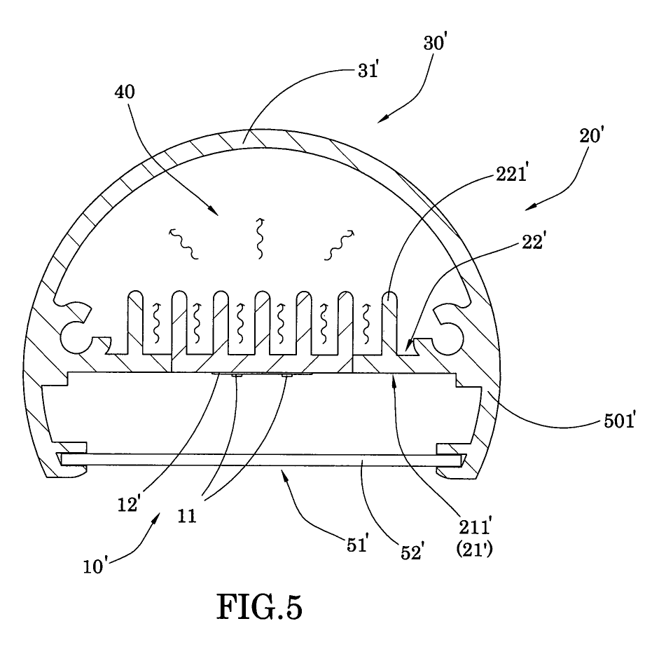

Referring to FIGS. 4 and 5, a LED light fixture according to a second preferred embodiment of the present invention is illustrated, which comprises a LED light arrangement 10′ and a supporting frame. The LED light arrangement 10′ comprises one or more LED diodes 11 as a light source of the LED light fixture to illuminate the surroundings.

The supporting frame comprises a heat transmitting wall 20′, which is made by heat conductive material, having a first side 21′ for supporting the LED light arrangement 10′ thereon, and a second side 22′ to define a heat transferring chamber 40 thereat in a concealed manner for containing gaseous in the heat transferring chamber 40. Therefore, the heat transmitting wall 20′ is arranged for conductively transferring heat from the diodes 11 at the first side 21′ to the second side 22′ of the heat transmitting wall 20′, and then convectively transferring the heat to the gaseous within the heat transferring chamber 40.

In other words, the heat generated from the diodes 11 is conductively transferred via the heat transmitting wall 20 from the first side 21 to the second side 22, and then convectively transferred the heat from the second side 22 of the heat transmitting wall 20 to the gaseous within the heat transferring chamber 40.

Therefore, the heat generated from the diodes 11 of the LED light arrangement 10′ is able to be effectively dissipated from the gaseous at the heat transferring chamber 40 to the surroundings through automatically ventilation, which is mainly depends on heat convection.

The supporting frame also comprises a concealing frame 30′ preferably made of a heat conductive material, wherein the concealing frame 30′ is extended from the heat transmitting wall 20′ to form the heat transferring chamber 40 within the heat transmitting wall 20′ and the concealing frame 30′. The heat transmitting wall 20′ is is preferably rectangular shape.

The concealing frame 30′ comprises a concealing wall 31′ and two end walls 32′, wherein the concealing wall 31′ is longitudinally extended from two longitudinal sides of the heat transmitting wall 20 to form the heat transferring chamber 40 within the heat transmitting wall 20′ and the concealing wall 31′. The end walls 32′ are further coupling with two transverse edges of the heat transmitting wall 20′ to conceal the heat transferring chamber 40′ within the heat transmitting wall 20′, the concealing wall 31′ and the two end walls 32′.

Accordingly, the heat transmitting wall 20′ is made by a heat conductive material having a higher heat conductive coefficient than the material of supporting frame 30′. Thus, the heat transmitting wall 20′ and the supporting frame 30′ are individually made by two different materials having different heat conductive coefficient, wherein the supporting 30′ is further extended from the two longitudinal sides of the heat transmitting wall 21′ to form the heat transferring chamber 40 therewithin.

A circuit layer 12′ of the LED light arrangement 10′ is embodied to be directly printed on the first side 21′ of the heat transmitting wall 20′, so that a heat generated from the circuit layer 12′ for operatively driving the diodes 11 is able to be efficiently transferred via the directly contact with the heat transmitting wall 20′ and the higher heat conductive coefficient material of the heat transmitting wall 20′.

In order to ventilate the gaseous within the heat transferring chamber 40, a plurality of ventilation openings 33′ are further provided at the concealing frame 30′ for thermally communicating with the heat transferring chamber 40 with the surroundings, which may be at the cooler room temperature than the temperature of the gaseous within the heat transferring chamber 40. It is appreciated that the ventilation openings 33′ may be provided at the concealing wall 31′ and/or end walls 32′ of the concealing frame 30′. In this preferred embodiment, the ventilation openings 33′ are provided at the concealing wall 31′ to convectively transfer the heat from the heat transferring chamber 40 to exterior.

The circuit layer 12′ of the LED light arrangement 10 is integrally provided on the first side 21′ of the heat transmitting wall 20′ for being supported thereon. The circuit layer 12′ is adapted for operatively and electrically connected to a power source, such as an external AC power source, for providing an electric power for performing the diodes 11, so that the circuit layer 12′ may generates a considerable among of heat generated therefrom. Therefore, the heat transmitting wall 20′ having the circuit layer 12′ printed thereon is thermally communicating with the diodes 11 and the circuit layer 12′ for conductively transferring the heat to the surroundings.

As shown in FIGS. 4 and 5, a plurality of heat transmitting fins 221′ are further provided at the second side 22′ of the heat transmitting wall 20′, wherein the heat transmitting fins 221′ are extended from the second side 22′ to protrude toward the heat transferring chamber 40, so that the heat generated from the diodes 11 and the circuit layer 12′ of LED light arrangement 10′ are able to be efficiently and conductively transferred due to the enlarged heat conduction area of the protruding heat transmitting fins 221′. Thus, the heat generated from the LED light arrangement 10′ is able to be efficiently removed away therefrom, so as to ensure the stability of normally operating the LED light fixture.

In other words, the heat transmitting fins 221′ protruded out from the second side 22′ of the heat transmitting wall 20′, preferably in a parallel protruding manner to integrally extended from the second side 22′ of the heat transmitting wall 20′, increases a total heat conducting surface of the heat transmitting wall 20′ to conductively transfer the heat from the first side 21′ to the second side 22′, so as to minimize a heat transferring rate for increasing the heat transferring efficiency without changing the original configuration of the supporting frame. Thus, the total size of the LED light fixture is remaining the same, so as to minimize the volume of the LED light fixture.

Accordingly, the heat generated from the diodes 11 and the circuit layer 12′ printed directly on the first side 21′ is able to be more efficiently transferred to remove the heat accumulated within the LED light fixture. The heat transmitting fins 221′ enlarged the heat conduction area at the second side 22′ enhance the conductively transferring the heat generated form the LED light arrangement 10′. Through the increased heat conducting area of the heat transmitting fins 221′ to thermally communicate with the heat transferring chamber 40, the heat is able to be removed to remain the operating temperature of the LED light arrangement 10′.

It is worth to mention that the heat transmitting fins 221′ enlarged the heat conducting surface are concealed within the heat transferring chamber 40 via the concealing frame 30′, so that the dust existed in the surroundings is relatively more difficult to stick on the heat transmitting fins 221′, so as to prevent the decreasing of heat transferring rate to cause the heat over accumulated within the supporting frame 30′. The over accumulated heat may lead to the abnormal operation of the LED light fixture and reduce the life time and durability thereof.

It is appreciated that the heat transmitting fins 221′ being concealed within the supporting frame 30′ not only increases the heat transferring efficiency via enlarging the heat conducting surface, but also remains a smooth outer surface of the concealing wall 31′, so as to be easily installed on the wall or with other objects.

The concealing wall 31′ is embodied as a C-shaped cross section longitudinal extended from the two longitudinal sides along the heat transmitting wall 20′ to define an approximate semi-circular shaped cross section of heat transferring chamber 40 therewithin. In other words, the C-shaped concealing wall 31′ and the heat transmitting wall 20′ are formed a approximately semi-circular column to define the heat transferring chamber 40 having the approximately semi-circular shaped cross section to conceal the heat transferring fins 221′ therewithin.

It is worth that the C-shaped concealing wall 31′ has a smooth outer surface, so that it is easier for installation of the LED light fixture. The heat transmitting fins 221′ protruded from the second side 22′ of the heat transmitting wall 20′ are provided within the heat transferring chamber in a concealed manner, so that the heat transferring rate is increased via the increased heat conduction area through the heat transmitting fins 221′ without increasing the overall size of the LED light fixture.

Each of the two end walls 32′ made by heat conductive material may further has an approximately semi-circular shape in accordance with the approximately semi-circular cross section shape of the heat transferring chamber 40, so as to conceal the heat transmitting fins 221′ in the heat transferring chamber 40.

As mentioned above, the supporting frame further comprises a mounting frame 50′ extended from the first side 21′ of the heat transmitting wall 20′ to form a lighting cavity between the heat transmitting wall 20′ and the mounting frame 50′, wherein the LED light arrangement 10′ supported by the heat transmitting wall 20′ is supported within the light cavity. The mounting frame 50′ is extended from the first side 21′ to define a light opening 51′ of the light cavity for aligning with the diodes 11 of the LED light arrangement 10′, so that the light generated from the diodes 11 is able to emit from the light opening 51′. The mounting frame 50′ is also preferably made by heat conductive material for enhancing the heat transferring ability.

The mounting frame 50′ also comprises a transparent cover panel 52′ supported at the light opening 51′ to enclose the LED light arrangement 10′ in the light cavity within the cover panel 51′, mounting frame 50′, and the heat transmitting wall 20′. Thus, the LED light arrangement 10′ is able to be protected within the light cavity and emit the light generated from the diodes 11 through the transparent cover panel 52′.

The mounting frame 50′, as described in this embodiment, further comprise two mounting walls 501′, which is preferably made by heat conductive material, wherein the mounting walls 501′ are longitudinally extended from the first side 21′ of the heat transmitting wall 20′ to define the light opening 51′, so as to support the cover panel 52′ spacedly apart from the first side 21′ of the heat transmitting wall 20′. It is appreciated that the heat conductive coefficient of material of heat transmitting wall 20′ is greater than the material of the mounting walls 501′ of the mounting frame 50′.

It is worth to mention that the heat transmitting wall 20 is made by a higher heat conductive coefficient material than the mounting walls 501′ and the concealing frame 30′, wherein the materials of the mounting walls 501′ and the concealing frame 30′ have a relatively more rigid characteristic for supporting the LED light arrangement 10′. The heat transmitting wall 20′, thus, is made by a relatively softer material having the higher heat conductive coefficient for enhancing the heat transferring rate to reduce the heat accumulated within the LED lighting fixture.

The two end walls 32′ of the concealing frame 30′ are coupled at the two transverse sides of the concealing wall 31′, heat transmitting wall 20′, and mounting walls 501′ to conceal the heat transferring chamber 40 and the light housing. In other words, the light housing supporting the LED light arrangement 10′ therewithin is defined between the heat transmitting wall 20′, the mounting walls 501′, the end walls 32′ and the transparent cover panel 52′ in this preferred embodiment.

It is worth to mention that the heat generated from the LED light arrangement 10′ also can be conductively removed from the mounting frame 50′ and the concealing frame 30′, which are preferably made by heat conductive material. The mounting walls 51′ and the concealing frame 30′ may be made by other materials, such as plastic, which is heat-resistant material for tolerating the heat generated from the LED light arrangement 10′.

The heat transmitting wall 20′ further has a reflective surface 211′ adapted for reflecting the light generated from the diodes 11 of LED light arrangement 10′, so that the light intensity is enhanced by reflecting the light generated from the diodes 11, so as to provide a relatively more efficiency LED lighting fixture.

Accordingly, the LED light fixture may also comprises one or more cable lines adapted for electrically connecting the circuit layer 12′ of the LED light arrangement 10′ to a power source for supplying the electric power to the LED light arrangement 10′. The end walls 32′ may further has one or more holes adapted for the cable lines to pass through from the lighting cavity to exterior via the holes.

Therefore, in both first and second embodiments of the present invention, the LED lighting fixture is able to efficiently transfer the heat generated from the LED light arrangement 10′ to exterior via heat conduction and heat convection. Meanwhile, the overall size and the outer smooth surface of the LED lighting fixture are remaining the same. The features of first embodiment and the second embodiment are interchangeable. For instance, the V-shaped cross section concealing wall 31 of the first embodiment is able to be extended from the longitudinal sides of the heat transmitting wall 20′ of the second embodiment. The circuit layer 12 of the first embodiment is able to be directly printed on the heat transmitting wall 20 as mentioned in the second preferred embodiment. The ventilation openings 33 and 33′ are capable of providing at either at the end walls 32 or end walls 32′, so as to provide at both end walls 32 or 32′ and concealing wall 31 or 31′ of the concealing frame 30, 30′.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A LED lighting fixture, comprising:
a LED light arrangement comprising one or more diodes spacedly and electrically coupling with each other for illumination; and
a supporting frame, which is made by heat conductive material, comprising a heat transmitting wall having a first side for said LED light arrangement supporting thereon, and a second side defining a heat transferring chamber thereat in a concealed manner for containing gaseous in said heat transferring chamber, wherein said heat transmitting wall is arranged for conductively transmitting heat from said diodes at said first side to said heat transferring chamber at said second side so as to effectively dissipating said heat from said gaseous heat transferring chamber to the surroundings through the ventilation of said gaseous within said heat transferring chamber.

2. The LED lighting fixture, as recited in claim 1, wherein said supporting frame further comprises a concealing frame integrally extended from said heat transmitting wall to define said heat transferring chamber within said second side of said heat transmitting wall and said concealing frame.

3. The LED lighting fixture, as recited in claim 2, wherein said concealing frame has a smooth outer surface.

4. The LED lighting fixture, as recited in claim 2, wherein said concealing frame has a ventilation opening formed thereat for communicating said heat transferring chamber with the exterior so as to enhance the ventilation of said gaseous within said heat transferring chamber for heat dissipation.

5. The LED lighting fixture, as recited in claim 3, wherein said concealing frame has a ventilation opening formed thereat for communicating said heat transferring chamber with the exterior so as to enhance the ventilation of said gaseous within said heat transferring chamber for heat dissipation.

6. The LED lighting fixture, as recited in claim 2, wherein said concealing frame comprises a concealing wall longitudinally extended along two longitudinal edges of said heat transmitting wall, and two end walls coupling at two transverse edges of said heat transmitting wall to conceal said heat transferring chamber within said concealing wall, said end walls, and heat transmitting wall.

7. The LED lighting fixture, as recited in claim 3, wherein said concealing frame comprises a concealing wall longitudinally extended along two longitudinal edges of said heat transmitting wall, and two end walls coupling at two transverse edges of said heat transmitting wall to conceal said heat transferring chamber within said concealing wall, said end walls, and heat transmitting wall.

8. The LED lighting fixture, as recited in claim 5, wherein said concealing frame comprises a concealing wall longitudinally extended along two longitudinal edges of said heat transmitting wall, and two end walls coupling at two transverse edges of said heat transmitting wall to conceal said heat transferring chamber within said concealing wall, said end walls, and heat transmitting wall.

9. The LED lighting fixture, as recited in claim 8, wherein said concealing wall has a V-shaped cross section longitudinally extending along said heat transmitting wall to define said heat transferring chamber having a triangular cross section.

10. The LED lighting fixture, as recited in claim 8, wherein said concealing wall has a C-shaped cross section longitudinally extending along said heat transmitting wall to define said heat transferring chamber having a semi-circular cross section.

11. The LED lighting fixture, as recited in claim 8, wherein said ventilation opening is formed at each of said end walls to communicate with said heat transferring chamber for ventilating said heat from said heat transferring chamber through said ventilation opening.

12. The LED lighting fixture, as recited in claim 8, wherein said ventilation opening is formed at said concealing wall to communicate with said heat transferring chamber for ventilating said heat from said heat transferring chamber through said ventilation opening.

13. The LED lighting fixture, as recited in claim 1, wherein said supporting frame further comprises a plurality of heat transmitting fins spacedly extended from said second side of said heat transmitting wall within said heat transferring chamber in a concealed manner for effectively transmitting said heat from said LED light arrangement to said heat transferring chamber.

14. The LED lighting fixture, as recited in claim 5, wherein said supporting frame further comprises a plurality of heat transmitting fins spacedly extended from said second side of said heat transmitting wall within said heat transferring chamber in a concealed manner for effectively transmitting said heat from said LED light arrangement to said heat transferring chamber.

15. The LED lighting fixture, as recited in claim 8, wherein said supporting frame further comprises a plurality of heat transmitting fins spacedly extended from said second side of said heat transmitting wall within said heat transferring chamber in a concealed manner for effectively transmitting said heat from said LED light arrangement to said heat transferring chamber.

16. The LED lighting fixture, as recited in claim 1, wherein said supporting frame further comprises a mounting frame extended from said first side of said heat transmitting wall to define a light opening aligning with said LED light arrangement, and a transparent cover panel supported at said light opening to enclose said LED light arrangement between said cover panel and said heat transmitting wall.

17. The LED lighting fixture, as recited in claim 8, wherein said supporting frame further comprises a mounting frame extended from said first side of said heat transmitting wall to define a light opening aligning with said LED light arrangement, and a transparent cover panel supported at said light opening to enclose said LED light arrangement between said cover panel and said heat transmitting wall.

18. The LED lighting fixture, as recited in claim 15, wherein said supporting frame further comprises a mounting frame extended from said first side of said heat transmitting wall to define a light opening aligning with said LED light arrangement, and a transparent cover panel supported at said light opening to enclose said LED light arrangement between said cover panel and said heat transmitting wall.

19. The LED lighting fixture, as recited in claim 16, wherein said mounting frame comprises two mounting walls longitudinally and integrally extended from said heat transmitting wall to support said cover panel spacedly apart from said first side of said heat transmitting wall.

20. The LED lighting fixture, as recited in claim 17, wherein said mounting frame comprises two mounting walls longitudinally and integrally extended from said heat transmitting wall to support said cover panel spacedly apart from said first side of said heat transmitting wall.

21. The LED lighting fixture, as recited in claim 18, wherein said mounting frame comprises two mounting walls longitudinally and integrally extended from said heat transmitting wall to support said cover panel spacedly apart from said first side of said heat transmitting wall.

22. The LED lighting fixture, as recited in claim 1, wherein said first side of said heat transmitting wall is a light reflective surface adapted for reflecting light generated from said diodes.

23. The LED lighting fixture, as recited in claim 8, wherein said first side of said heat transmitting wall is a light reflective surface adapted for reflecting light generated from said diodes.

24. The LED lighting fixture, as recited in claim 21, wherein said first side of said heat transmitting wall is a light reflective surface adapted for reflecting light generated from said diodes.
